(19) United States
(12) Patent Application Publication
(10) Pub. No.: US 2020/0250558 A1
(43) Pub. Date: Aug. 6, 2020

(54) AUTOMATED SYSTEMS OF PROPERTY-BASED TYPES

(71) Applicant: David A. Fisher, Pittsburgh, PA (US)

(72) Inventor: David A. Fisher, Pittsburgh, PA (US)

(21) Appl. No.: 16/649,159

(22) PCT Filed: Nov. 29, 2018
(86) PCT No.: PCT/US2018/063037

§ 371 Date: Mar. 20, 2020

Related U.S. Application Data
(60) Provisional application No. 62/595,679, filed on Dec. 7, 2017.

(51) Int. Cl. G06N 5/04; G06N 5/02

(52) U.S. Cl. CPC G06N 5/045; G06N 5/02

(57) ABSTRACT

An automated system and method uses a recursive information structure and an intensional incomplete calculus of types to validly characterize anything imaginable; extend applications of automated systems to infinite and incomplete domains; guarantee valid results the absence of complete information; emulate abstraction, generalization, analogy, and other inference rules of human reasoning; execute high performance proofs; simplify application development through increased automation; employ problem solving methods of the human mind, and enable new methods for natural language processing.

### PRIORITY CLAIM

The present application claims priority to U.S. provisional patent application Ser. No. 62/595,679, filed Dec. 7, 2017, with the same title and inventor as the present application, and which provisional application is incorporated herein by reference in its entirety.

### BACKGROUND

Digital computers have unique abilities that are ideally suited for certain tasks including, number crunching computations, performing repetitive processes, processing very large data sets, and controlling certain input-output devices. Artificial intelligence (AI) technology extends computers to include reactive decision making applications that use perceptual evidence, pattern matching, experience based learning, and statistical inference. The human mind goes beyond the abilities of computers and AI to be able to identify inconsistencies, validly reason with incomplete information, understand the meaning of available information, communicate in informal language, validly reason about infinite domains, imagine worlds beyond its perceptions, and develop new concepts using abstraction, generalization and analogy. The logic of property based types (PBT) was developed to enable automated systems that emulate the above aspects of the human mind and to overcome the limitations of digital computers and AI.

### SUMMARY

This invention, in a general aspect, extends the range of valid applications of automated systems to include any imaginable domain, guarantees valid results in the absence of complete information, and solves complex problems beyond the capabilities of digital computers. It is built on a different mathematical foundation than digital computers and employs a reasoning engine that implements an incomplete, intensional higher-order logic of property-based types. It is analogous to a digital computer in that it serves as a platform that must be specialized to the needs of each application through a software development process, but differs from traditional computers in that it automates more of the software development process and has functional, quality, and performance characteristics that are radically different.

Its primitive abilities include abstraction, generalization, and analogy, which were previously unavailable in automated systems. Its methods are antithetical to those of artificial intelligence. Its use allows domain practitioners to understand and develop their own applications without knowledge of data structures, algorithms, or programming languages. It both enables informal language processing and uses informal language in its user interface. For aspects of applications in which digital computers are more cost-effective, this invention can be used to control a computer.

These and other benefits realizable through embodiments of the present invention will be apparent from the description below.

### FIGURES

Various embodiments of the present invention are described herein by way of example in conjunction with the following figures, wherein:

FIG. 1 is a diagram that illustrates the implementation of a type according to various embodiments of the present invention;

FIG. 2 depicts an example type lattice according to various embodiments of the present invention;

FIG. 3 illustrates a same operation that is used to mark types that have multiple references according to various embodiments of the present invention;

FIG. 4 illustrates a PBT proof generation process according to various embodiments of the present invention;

FIG. 5 is a diagram of a software development process according to various embodiments of the present invention;

FIGS. 6A and 6B are diagrams of a PBT system architecture according to various embodiments of the present invention;

FIGS. 7A and 7B illustrate PBT logic engines according to various embodiments of the present invention; and

FIG. 8 illustrates an architecture of a generic application from a user perspective according to various embodiments of the present invention.

### DESCRIPTION

This disclosure describes an invention that lies at the intersection of mathematical logic, computer science, linguistics, and computer architecture. It describes the design of a new class of automated systems that avoids aspects of digital computers that are problematic while emulating aspects of human reasoning previously unavailable in automated systems. It employs information representations and logic that differ from those of digital computers.

It is based on three simple ideas: a property is a relationship among things; anything that can be imagined can be characterized by its properties; and the only things that can be known about anything are its properties. Although these ideas have been known for more than two millennia, they have not been exploited in automated systems.

This invention extends the range of valid applications of automated systems, automates more of the software development process, and increases user participation in the development and evolution of their applications. It guarantees valid results in the absence of complete information. Its major applications are likely unforeseen, but might include its uses as a reasoning assistant, as a way to enhance the reliability and understandability of automated systems, and as a way to eliminate the need for data structures, algorithms, and programming languages in software development. It comprises a new information structure (i.e., knowledge representation) called property based types (PBT), an associated logic that is radically different from that of digital computers, and a reasoning engine. The information structure can represent incomplete information and can be used to validly characterize anything imaginable. The logic is incomplete, higher-order, and intensional. It comprises inference rules for calculating previously unknown information and a process for generating proofs. The reasoning engine implements the logic to answer questions about things characterized by the information structure. The logic of property-based types is incomplete (i.e., allows application domains where complete knowledge is impossible), higher-order (i.e., proves consistency of types rather than properties of individual models or representations), intensional (i.e., represents the meaning of, instead of referencing, things), property based (i.e., characterizes but does not model or represent things), devoid of paradoxes, and infinite (i.e., can validly answer questions about infinite domains). PBT logic has intrinsic meaning in which the system itself understands the meaning of its structures and can explain its own decisions.

PBT logic contrasts with classical logic on which digital computers are based. Classical logic operates on propositions which are sequences of symbols in a formal language, complete (i.e., falsely assumes that every property of the application domain is either true or false), extensional (i.e., meaning resides only in the minds of external human observers), and paradoxical (i.e., paradoxes are inherent in the logic).

Digital computers employ a calculus of representational models in which attributed properties are represented by fields of mutable data structures, structural properties by records and pointers, and behavioral properties by algorithms that modify variables and data structures. The logic of digital computers is based on classical logic, but limited to finite domains.

Artificial intelligence (AI) systems suffer the limitations of digital computers, but with the additional hardship of decision processes that cannot be understood by either their developers or users. AI technologies exploit capabilities of digital computers that are unavailable in human reasoning to accomplish tasks that, if performed by humans, would appear intelligent. PBT systems are philosophically antithetical to AI technologies because PBT systems emulate aspects of the human mind that conflict with the principles of digital computer instruction set architectures. While PBT methods depend on meaning and a few simple operations including abstraction and generalization, AI methods often depend on heuristics and extrapolation from vast quantities of specialized but inconsistent data.

A PBT system does not require complete information and guarantees valid results in the absence of complete information, but when the known information is insufficient to answer a question, may ask for additional information or return a range of answers. A PBT reasoning engine operates on property-based types to implement the PBT logic. A reasoning engine is the keystone of every automated system of property-based types.

Digital computers have long been viewed as enablers of an intellectual revolution rivaling the industrial revolution, but, after more than 60 years of modern computing, remain effective only for tasks that are limited to number crunching, control of devices, highly structured data, repetitive execution, statistical properties, or stochastic results.

Property-based types offer an alternative foundation for automated systems that guarantees valid results and does not require complete information. The industrial revolution was triggered by the availability of new raw materials and energy sources that enabled the mass production of manufactured goods and magnified the mechanical abilities of individuals and systems. An intellectual revolution may be triggered by automated reasoning technologies that produce valid results and collaboratively reason with people to magnify the reasoning abilities of individuals and systems.

The primary innovations of this invention, according to various embodiments, include:
An information structure that validly characterizes anything imaginable, represents any property without having to include unknown properties, allows calculations on infinite types, and enables intrinsic meaning. In contrast, digital computers require complete models built from data structures and algorithms, are limited to finite domains, and have no inherent meaning.
An automatable logic that combines the advantages of incomplete, higher-order, and intensional logics. In contrast, digital computers employ a logic that is complete, model based, and extensional.
A method for feasibly implementing the structures and logic, even though they cannot be composed from the complete structures and logic of digital computers.
A software development process that allows declarative specification of applications using informal language, increases user participation in application development, and eliminates the need for developers to understand data structures, algorithms, programming languages, or computer science methods. The process includes an efficient proof generation process and is able to perform linguistic analysis and synthesis from/to property-based types.
An informal declarative linguistic interface that can validly express information that is vague, incomplete, or imprecise. In contrast, digital computers require formal programming languages that are imperative and require complete and unambiguous specifications.
A reasoning engine that implements the structures and logic, including a proof generation process, an automated software development process, and an informal linguistic interface.

An Information Structure: The information structures of property-based types involve three concepts: types, properties, and examples. In the logic of property-based types, a type is an abstract (i.e., incomplete) characterization of something and is represented by a logical composition of properties. Because a type is incomplete, it characterizes the category of things that satisfy its properties.

A property is a relationship among types that corresponds to a relationship among the things characterized by its respective argument types. An example of a type is anything that satisfies the properties of the type. For example, “dogs are mammals that bark” defines the type dog by two properties, namely, its examples are mammals and they bark. While dog is an abstract type or concept, every example of dog is an actual physical thing.

While types and their properties reside entirely within the system, their examples neither exist nor are represented within the system. Instead, they reside in some physical, abstract, or computational world independent of the system. The logic of property-based types uses neither symbols to name things (e.g., as does propositional calculus) nor object models to represent things (e.g., as do digital computers).

A property is a relationship comprising a subject, an operation, and zero or more additional arguments where the subject, relation, and other arguments are themselves types. Every type has a value, which is the category of things (i.e., examples) characterized by its properties. Every type also has an associated Boolean value indicating whether its properties are consistent.

Thus, unlike the complete models (i.e., data structures) required by digital computers, property-based types can represent any known property without including information that is unknown. Property-based types constitute a universal information structure that can validly but incompletely characterize anything imaginable.

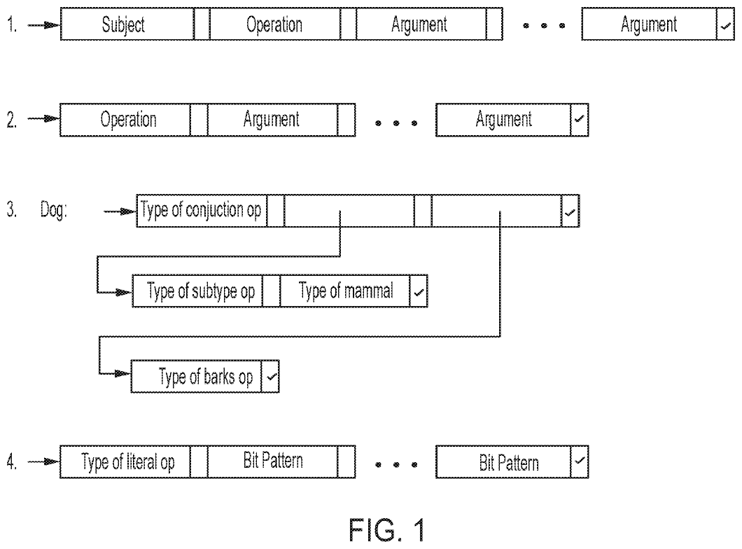

The first line of FIG. 1 shows an implementation of a type. A type is represented by a recursive information structure comprising a pointer to a property where each property is represented by a sequence comprising the type of the subject, the type of the operation, and the types of the other arguments. The pointer is a memory index or address of the property, provides a unique identity for the type, and allows the type to be referenced from multiple places without replicating the memory for its properties. Because the sequence is variable length, a one bit field is associated with each pointer to indicate whether (i.e., indicated by a check mark in FIG. 1) or not (i.e., indicated by blank in FIG. 1) it is the last element in the sequence.

Alternatively, a sequence could be implemented as a linked list or as an array with a length field. We prefer the marked element method because it is simple and regular, does not impose processing costs of managing length counts, and requires the least memory for short sequences.

The second line of FIG. 1 shows an optimization. Because each type defines the category of things that satisfy the type's property, and so does the subject, the subject field of a property is identical to its pointer. The subject field of every type may be omitted without loss of information.

The third line of FIG. 1 shows a more complete example illustrating the implementation structure for “dogs are mammals that bark” or, more directly, “a dog is a conjunction of it is a mammal and it barks.”

Communications between components of traditional automated systems require the components to send and receive bit patterns that have no inherent meaning and whose interpretations are established by convention between the components prior to the communication and often at system design time. Communications between the PBT reasoning engine and traditional components have similar restrictions. Bit patterns, however, are things (i.e., examples of literals) and cannot be represented using the type structure alone. The fourth line of FIG. 1 shows a special case structure for a literal type where each literal type has exactly one example that is a particular bit pattern. In the implementation of a literal type, the operation field contains a type of the literal operation and the argument fields contain the actual bit pattern.

Operations: Operations are crucial components of the PBT information structure. Every property has an operation and a sequence of arguments. Logical operations are used to express logical compositions of the argument's properties. Expressions with logical operations are called logical properties. Categorical operations are used to express relationships among examples that are categorized by the arguments. Expressions with categorical operations are called categorical properties.

Although every operation is user definable, a critical mass of built-in and predefined operations is desirable for bootstrapping and initial use of a PBT system. The operations shown in Tables I and II below constitute one possible embodiment.

Every operation shown in Tables I and II below is typical because its arguments and result are types. Depending on the operation, each argument may be interpreted as a type, as the property of a type, or as examples of a type. Logical operations, as shown in Table I, are analogous to the logical operations in the propositional calculus of classical logic. The recommended logical operations include and, or, not, and implication from classical logic plus unions and sequence of types that are also meaningful for types. Because the logic operations are known at system design time and few in number they should be built-in.

TABLE I
LOGICAL OPERATIONS

| | |
|---|---|
| P∧Q | The result of the conjunction of types P and Q is the type whose properties are |
| | the union of the properties of P and of Q. The operation is both associative and |
| | commutative. It is used to specialize types to their least restrictive common |
| | subtype |
| P∨Q | The result of the disjunction of types P and Q is either P or Q if both are |
| | consistent and otherwise false. The operation is both associative and |
| | commutative. It is used to indicate alternative subtypes. |
| ~Q | The result of the complement of a type Q is true if Q is inconsistent and |
| | otherwise false. The operation is used to indicate inconsistency of Q. |
| P→Q | The result of the implication of types P and Q is Q if P is inconsistent and P |
| | otherwise. The operation is neither associative nor commutative, but it is |
| | transitive. It is used to indicate entailment of properties. |
| P&Q | The result of the union of types P and Q is a type whose examples are the union |
| | of the examples of P and Q. The operation is associative and communities. It is |
| | used to form types whose examples do not have common properties and is |
| | especially useful to combine types that together constitute the context of a |
| | problem domain. |
| P~Q | The examples of certain types are ordered. The result of the catenation of ordered |
| | types P and Q is a type whose examples are ordered and consists of the sequence |
| | of examples of P followed by the sequence of examples of Q. The operation is |
| | associative but not commutative. It is used to construct sequences, often in time |
| | or space. |

Categorical operations, as shown in Table II, express relationships among examples of their arguments. They define categories of examples that satisfy the relations expressed by their operations. Depending on the type, the resulting properties may be called scientific principles, axioms, legal regulations, cultural norms, social conventions, rules of thumb, or other words used to name properties. Categorical operations are typically user defined, are domain specific, and may be combined using logical operations. For expository purposes within this document, symbols and words have been assigned to operations, but they are neither a part of the logic nor required by the representation of types.

TABLE II
CATEGORICAL OPERATIONS

| | |
|---|---|
| attribute[T;D;A] | The result of a attribution of types T, D, and A, where T is a type, D is a |
| | dimension, and A is an example of type S where S is similar to T but has an |
| | additional attributed property specifying that examples of S have an A as their |
| | value for dimension D (e.g., length weight, age, font, color). For example, |
| | “yellow colored dog” could be characterized by attribute [dog, color, yellow]. |
| | When a dimension has only two possible values, they are typically treated as |
| | true and false. Existence, mutable, and ordered are dimensions with only two |
| | values and they are assigned true and false. |
| prepose[T; R; A] | The result of a preposition of types T, R, and A], where T is interpreted as a |
| | type, R as a prepositional relation, and A as a thing, is a type S where S is |
| | similar to T but has an additional prepositional property specifying that |
| | examples of S ale related to A by the static relation R. For example, “dogs in |
| | the yard” could be characterized by attribute [dogs, in, the yard]. |
| possessive[T; A] | The result of a possesive of types T and A, where T is interpreted as a type |
| | and A as a thing, is a type S where S is similar to T but has an additional |
| | possessive property specifies that examples of S belong to or are part of A. |
| | For example, “the dogs bone” could be characterized by possessive [bone; the |
| | dog]. Possession in also used to indicate that a type has a particular dimension |
| | as in “physical things have mass” where mass is a dimension. |
| active[T; R; A] | The result of an action of types T, R, and A], where T is a type, R is an active |
| | (i.e., state changing) relation, and A is a thing, is a type S where S is similar |
| | to T but has an additional active property specifying that examples of S are |
| | related to A by the action R. For example, “dogs chase cats” could be |
| | characterized by active [dogs; chase, cats]. Some (i.e., intransitive) actions do |
| | not have a third argument. For example “bark” as in “dogs bark”. |
| exists [T; R; A] | The result of an “exists” assertion of a type T is a type S where S is similar to |
| | T but has an additional possessive property specifying that examples of S |
| | exist. For types with immutable examples, there is no distinction between |
| | existing and hypothetical examples, but for types with mutable examples, |
| | examples are assumed to be hypothetical until they are asserted to exist by an |
| | exists specification. For example, “There is a God” asserts that God exists. |
| lambda | The result of a lambda operation is a function with N arguments of types T1 |
| [T₁; T₂; . . .; T_{N}] | . . . TN respectively. For example, the square root function may be |
| | characterized by lambda [a number]Λ2 = the number. |

Because operations and arguments may be incomplete, lazy evaluation is the primary execution paradigm. That is, each type stands for the examples that it characterizes without the need for execution, evaluation, or other forms of refinement. Consequently, a type may be incompletely specified and executable algorithms are not required. Logical inference is used to simplify results.

Type Lattice: One of the most important tautologies (i.e., universal truths) of classical logic is the law of the excluded middle, which says that every property is either true or its complement is true. Much of the power and fascination of property-based types arise from denying this law. In PBT logic, a property may be either entailed by known properties (i.e., true), inconsistent with known properties (i.e., false), or consistent but not entailed by the known properties (i.e., the excluded middle state of classical logic).

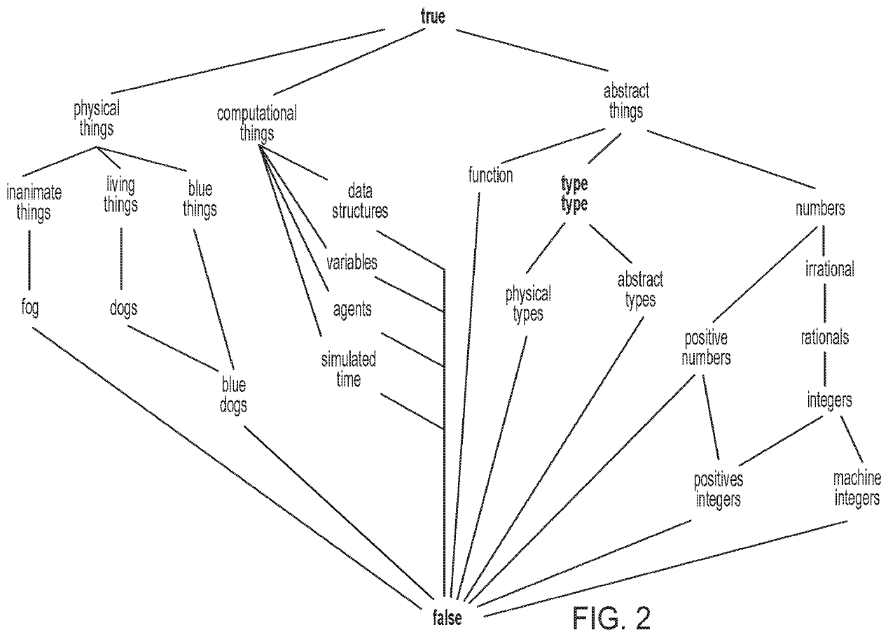

Consequently, types are logical conjunctions (i.e., sets) of properties that may be true, or false, or something in the middle. Properties define a partial ordering among types. For example, if dogs are mammals, then every property of mammals is also a property of dogs and thus dogs are said to be a subtype of mammals. FIG. 2 depicts a type lattice according to various embodiments of the present invention. The type lattice of FIG. 2 shows the subtype relationships among a variety of useful types. Each node represents a type. Each connecting line indicates that the type at its lower end is a subtype of the type at its upper end (i.e., a parent or super-type). The properties of a subtype are a superset of the properties of its parent types and every subtype characterizes a subset of the examples of its parent types. Omitting a property creates another type that characterizes not only the examples of the original type, but also examples that would be precluded by the omitted property. The subtype relation is the converse of the logical implication operation of Table I. Because implication and the subtype relation are transitive, lines are not shown between nodes that have an indirect path between them. Because a property of a parent is also a property of its subtypes, properties are said to inherit down the lattice.

The universal type is the top node of the lattice in FIG. 2 and is the empty set of properties. It is often called true because, without properties, anything that can be imagined satisfies all of its properties. Because no consistent type can be a subtype of an inconsistent type, consistent types occupy only the upper portion of the type lattice, while inconsistent types occupy only the lower portion of the lattice. Because all inconsistent types are logically equivalent, false serves as the canonical inconsistent type and is treated as if it contains every possible property. Because false is inconsistent, it cannot have examples.

The lattice shows the distinction between physical, computational, and abstract types. Examples of physical and computational things are mutable while those of abstract things are immutable. The differences between living things and blue things show that types can be distinguished in multiple dimensions. The numbers type has several useful subtypes, including irrationals and integers, that cannot be validly accommodated by programming languages or digital computers because computers require finite representations. Type type is the type of all types, is an example of itself, and does not have an analogy in set theory, classical logic, or digital computers. Because all types are examples of type type, type type is the only type required at the implementation level of a PBT system. Function is the type of all things with parameters.

Designational Operations: Designational operations, as shown in the example of Table III, differentiate types on properties other than characteristics of their examples. Designational operations designate certain examples of their argument types. They define a subtype of their argument that is constrained, not by characteristics of the examples, but by the number of examples or how the examples are selected. A property with a designational operation as its primary operation is called a designational property. They typically restrict a type to a subset of its examples by conditions that involve the category as a whole, rather than individual examples. For example, a quantity property restricts a type to a specified quantity of its examples. A definite property specifies whether specific or arbitrary examples are intended. Index is used to designate an example by its ordinal position within an ordered type.

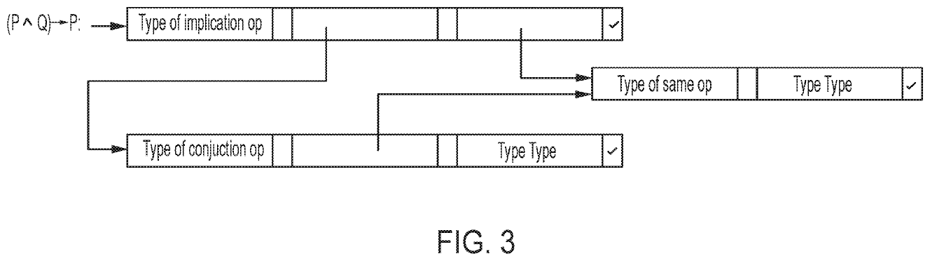

TABLE III
DESIGNATIONAL OPERATIONS

| | |
|---|---|
| Literal [X] | The result of the literal operation is a type for which the only example is |
| | the bit pattern X. |
| Definite [a type; true | Definite indicates whether examples of a type are definitely (i.e., |
| or false] | specifically) or indefinitely (i.e., arbitrarily) designated. For example, “the |
| | dog” versus “a dog”. |
| Quantity [a type; | The quantity operation returns a subtype of its argument type with the |
| quantity] | specified quantity of examples. The quantity may be vague (e.g., some, |
| | many), precise (e.g., 23), or imprecise (e.g., a measured value such as 4.5 |
| | meters). For example, “five dogs”, “many cats”, or “3.7 grams”. |
| Index [an ordered | The index operation returns as ordered subtype of its first argument, but |
| type; an index | with only those examples at the specified index positions. For example, |
| position] | “the second and fifth chapters”. |
| Only [a type] | The only operation returns a type similar to its argument but with an |
| | additional property indicating that the type cannot be generalized to a larger |
| | quantity of examples nor to a super type. For example, “only three dogs” or |
| | “only cats”. |
| Other [a type] | The other operation returns a subtype of its argument, but without those |
| | examples that have already been designated in the current context. For |
| | example, “the other cats”. |
| What [a type] | What is a marker operation that when applied to a type indicates that more |
| | information about the type is desired. |
| Self [a type] | Self returns the property of being an integral part of the PBT system itself. |
| Same [a type] | The same operation returns a type that is equivalent to its argument, except |
| | that multiple occurrences of a same property are interpreted as designating |
| | the same examples. Use of the same operation is unambiguous but is |
| | otherwise analogous to use of relative pronouns in natural language. An |
| | example using same is in FIG. 3 for (P ∧ Q) → P where the two P's |
| | designate the same type, but Q designates a type independent of P. |
| Assume [a property] | Marks a property to be valid without evidence to support that claim. It |
| | allows to property to be identified later if it critical to a proof. |
| Name [a literal; a | The name operation specifies that a literal is a word of a particular part of |
| part of speech; a | speech in the designated language. The word names the result type. Names, |
| language] | like other properties, inherent to their subtypes. |

What is a marker that focuses attention where the user would like more information. A property containing a what operation is called an interrogative property. What corresponds to who, where, what, when, and how in English questions depending on whether it is applied to a type that characterizes a person, place, thing, time, or action, respectively. Self indicates a type whose examples are an integral part of the PBT system. It allows users to ask, and the system to answer, questions about the structures, decision processes, and other aspects of the system.

Whether multiple occurrences of a type within a property designate the same examples depends on their definiteness. If a subsequent occurrence is definite, it designates the same examples. If it is indefinite, it does not necessarily designate the same examples. An example of same definiteness is given in FIG. 3.

Limiting its properties to those that are known to be valid is necessary for validity and often precludes axiomatic completeness. Many domains are Godel incomplete (i.e. they have an uncountable number of independent properties) and thus not all questions are answerable.

An Incomplete Logic. A logic is a theory of reasoning. It requires a way to represent known properties of things, a way to represent questions about those things, inference rules to calculate previously unknown properties from known properties, a process to determine which inference rules to apply to which properties and in what order, and a way to represent results. The known properties are called axioms, the calculations are called proofs, and the resulting properties are called theorems. In a PBT system, the axioms, theorems, inference rules, questions, and answers are all represented by property based types. The unification of axioms and inference rules is of particular value because it simplifies the proof process and automatically extends inference rules to each new (i.e. axiomatically defined) application domain.

The logic of property-based types is designed to overcome several important limitations of classical logic: the inability to guarantee valid results without complete information, the presence of paradoxes, and the absence of intensional meaning. PBT logic combines the advantages of incomplete, higher-order, and intensional logics. In contrast, digital computers employ a logic that is complete, model based, and extensional.

Although digital computers and classical logics assume and require that every property be either true or false, Kurt Godel's first incompleteness theorem, which was published in 1931, demonstrates that any domain as complex as natural numbers cannot be characterized by a finite (or even infinite algorithmically generated) set of axioms. Except for a few simple mathematical domains, it is impossible to know everything about anything for most domains, including those of physical, biological, social, or economic worlds. No matter how much is known there will remain properties whose truth cannot be determined from what is known. Because digital computers require complete characterizations, they seldom can guarantee valid results. For example, any result that depends on a false assumption that the application domain is complete is invalid.

PBT logic treats every domain as if it were incomplete, allowing users to include only known information. Previous attempts to create an incomplete logic have been unsatisfying because, without the law of the excluded middle, classical logic becomes nonmonotonic (i.e., a proofs may be later invalidated by new information) and indirect proofs (i.e., a frequently used method in which a property is proven by assuming its complement and then proving false) becomes invalid.

PBT logic precludes paradoxes. The history of classical logic from the time of Aristotle (384-322 BCE) has been one of repeatedly discovering and eliminating paradoxes by adding rigor to the logic. In 1903, Bertrand Russell showed that paradoxes could be avoided by using a higher-order logic. A higher-order logic answers questions about logics (i.e., sets of properties) rather than individual properties. PBT logic is higher-order and avoids paradoxes because it calculates only with types and every type is a set of properties corresponding to a set of axioms in classical logic.

As a calculus of types, PBT logic proves consistency of types rather than entailment of properties. Types have only two states (i.e., consistent and inconsistent). Every type is immutable and completely characterized by its properties, even though it incompletely characterizes its examples. Thus, PBT logic allows the law of the excluded middle with respect to consistency of types and thus is monotonic.

PBT logic, like intensional logics, is a logic of sense and meaning rather than of references and representations. The difference between sense, which is the meaning of something, and reference, which is the things designated by that meaning, was identified by Gottlob Frege in 1892. For example, although the sense of “the morning star” is distinct from the sense of “the evening star,” they both reference the planet Venus. Digital computer and classical logics are extensional logics because they calculate with models and symbols that represent and reference things, while meaning resides only in the minds of their external human observers. PBT logic is intensional, uses neither models nor symbols to reference things and instead calculates only with types.

Intrinsic Meaning: PBT logic goes beyond intensional logic to have intrinsic meaning. Incompleteness guarantees that every known property can be represented and that any unknown property may be omitted. That the properties of a type are represented by sequences of types means that its intensional interpretation recursively includes the interpretations of its constituent types. Thus, meaning in a PBT system resides not in individual properties or types, but in the patterns of interconnections among the types. Any relationship among things that is known outside the system can be represented within the system. As in a dictionary, every word is defined by its relationships to other words without the need for grounding by some primitive preexisting words. Anything that a person can deduce from those relationships can also be deduced by a PBT system. In this way, both the human mind and a PBT system can encode a valid, but incomplete, characterization of anything real or imagined, and can deduce anything that is entailed by that knowledge. Property-based types, like concepts of the human mind, accurately represent known relationships among things, but do not represent or model individual things.

The combination of intrinsic meaning that allows a PBT system to understand rather than model things combined with complex decision-making in an incomplete logic may establish a unique context of imagination and creativity. Types in a PBT system are analogous to concepts in human reasoning. Imagination is the ability to form new ideas or concepts of things not presented to the senses. A combination of intensional meaning, incomplete characterizations, and use of the inference rules for incomplete types should allow a PBT system to generate and answer its own questions. Analogy, in particular, allows concepts and methods from one domain to be reused in other domains. Creativity is the use of imagination. PBT systems may demonstrate imagination and creativity.

Infinite Domains: Because PBT logic does not represent individual examples, it does not matter whether the number of examples of a type is finite, countable, or uncountably infinite. Digital computer logic, on the other hand, has finite memory and models individual examples. Thus, computers can neither represent nor answer questions about infinite domains. For example, computers cannot implement numbers that satisfy the Peano axioms and, instead, limit their integers to a finite cycle of values. Because property-based types are incomplete and property based they are not limited to finite or even countably infinite domains.

Tautologies: A tautology is a property that is valid independent of the application domain. In PBT systems, tautologies are axioms of type type and thus are valid for all types (i.e., all examples of type type). Some important tautologies are shown in Tables IV(A) and IV(B). The first group of tautologies in Table IV(A) is identical in form to tautologies of classical logic, but asserts relationships about the consistency of types rather than the entailment of properties. The first three tautologies are analogous to Aristotle's classical laws of thought. In PBT logic, modus ponens says that if type S is consistent and if the consistency of type S implies the consistency of type T, then type T must also be consistent. Although the law of the excluded middle is invalid for entailment of properties in many domains, it is valid for consistency of types in all domains. In particular, every set of properties is either consistent or inconsistent as determinable from its immutable set of properties. More broadly, every tautology of classical logic is isomorphic to a tautology of PBT logic, and thus every inference rule and proof method of classical logic is applicable to PBT logic.

TABLE IV(A)
TAUTOLOGIES OF PBT LOGIC - PART ONE

| | |
|---|---|
| Law of Identity | T → T |
| Law of Non-Contradiction | [symbol] (T ∧ [symbol] T) |
| Law of the Excluded Middle | T ∨ [symbol] T |
| Modus Ponens | (S ∧ (S → T))→T |
| Simplification | (S ∧ T) → S |
| De Morgan's Laws | ( [symbol] (S ∧ T))→(( [symbol] S)∨( [symbol] T)) |
| | ( [symbol] (S ∨ T))→(( [symbol] S)∧( [symbol] T)) |

The second group of tautologies in Table IV(B) involves incomplete types with interpretations that are not meaningful in classical logic nor in the complete logic of digital computers. Abstraction says that if (S∧T) is a consistent type, then T is a consistent abstraction of (S∧T). Specialization says that if a consistent type T can be proven from a consistent S, then (S∧T) is a consistent specialization of S. Generalization says that if R[S∧T] is consistent and T, Q, and R do not contradict each other, then R[S∧Q] is consistent. That is, the operation R can be generalized from subtype (S∧T) to subtype (Q∧T) even when (S∧Q) is inconsistent. Analogy is a special case of abstraction in which the eliminated properties of S are viewed by the user as particularly important to type (S∧T).

TABLE IV(B)
TAUTOLOGIES OF PBT LOGIC - PART TWO

| | |
|---|---|
| Abstraction | (S ∧ T) → T |
| Specialization | (S → T) → (S ∧ T) |
| Generalization | (R[ S ∧ T] & (T ∧ Q ∧ R) → R[T ∧ Q] |
| Implication from Consistency | ((S ∧ T) & [symbol] (S ∧ [symbol] T)) → (S → T) |
| Analogy | (S ∧ T) → T |
| Metaphor | ((S ∧ T) & (R ∧ S)) → (R ∧ T)) |

Metaphor is related to analogy, but replaces the primary type T by another type Q that is consistent with S. Implication from consistency says that if (S∧T) is consistent, but (S∧¬T) is inconsistent then (S→T). It is important because it can be used to prove entailment of properties using PBT logic.

Inference Rules: An inference rule is a function that transforms a pattern of logical compositions into another pattern that is consistent with the first pattern. An axiom with implication as its primary operation (e.g., P→Q) can be interpreted as an inference rule in which an occurrence of P can be replaced by Q. An axiom P without implication as its primary operation can be rewritten as true→P and then interpreted as an inference rule. Execution in a PBT system is a process of replacing part of a type's structure using an inference rule to produce a new entailed type that is closer to a desired type.

Some of the tautologies in the second group of Table IV have particular roles in PBT proofs. Abstraction is used to reduce the number of properties that must be considered in subsequent proof steps. Specialization is used to return to the original type once the proof has been completed in a simpler, more abstract type. Generalization is used to broaden the types that can be used as arguments to a known operation. Abstraction, specialization, generalization, and analogy are among the most powerful inference rules of human reasoning, but require incomplete types and thus cannot be implemented within digital computer or classical logic. Abstraction, specialization, generalization, and analogy are very efficient to implement in PBT systems because they involve only subtracting or adding properties as one moves up or down the type lattice.

Proofs: A proof is a sequence of applications of the inference rules starting with the axioms and ending with a desired theorem. In PBT logic, a proof calculates a new type (i.e., the theorem) from a set of known types (i.e., the axioms) by application of the inference rules where every type is viewed as a set of properties. Each type categorizes a set of examples and is represented by a logical composition of properties that is either consistent or inconsistent. This duality defines two values for each type: the category of its examples and a boolean value indicating its consistency. In contrast, a proof in classical logic produces a boolean value that answers whether a particular proposition is or is not entailed by the axions. A proof in digital computers is a program that produces new logically complete models (i.e., data structures) that are entailed by the initial state as in a simulation.

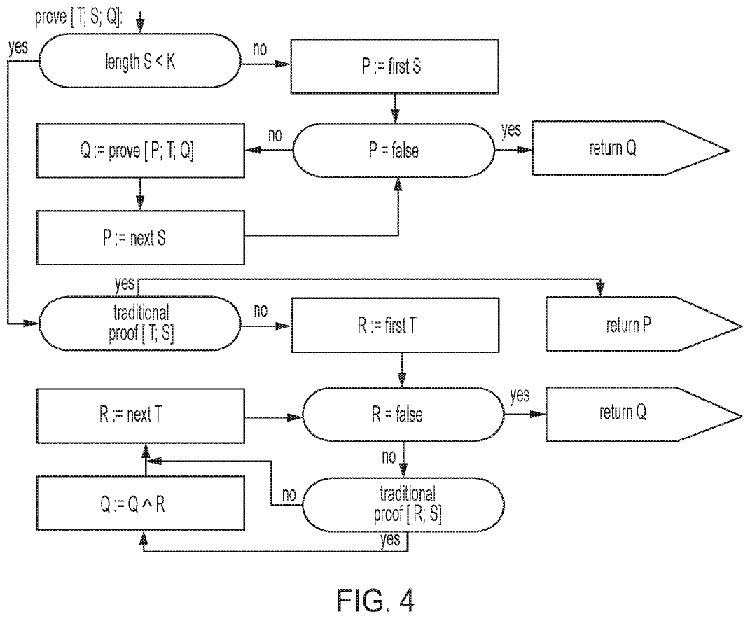

FIG. 4 illustrates a PBT proof generation process according to various embodiments of the present invention. PBT logic enables a uniquely efficient proof generation process, as shown in FIG. 4. The prove routine has three parameters T, S, and Q, where T is the type to be proven; S is the type of the application domain, and Q is a super type of T that is already known to be consistent with S. Typically, Q is initially true, meaning that nothing has been proven. The routine returns the super type of T that has the most properties and fewest examples, which is consistent with S.

The process involves two sequential loops. The top loop iterates recursively through the super types of S (i.e., ancestors of S in the lattice) finding those with no more than K properties for some global constant K. At that point it attempts to prove the consistency of type T directly (i.e., without examining T′s properties) in the ancestor context of S using the proof methods of classical logic and the inference rules of PBT logic. If that is unsuccessful, the second loop of FIG. 4 is used to iterate through the properties of T (i.e., T′s parents in the lattice), attempting to prove each one in the context S using traditional methods, and at each success adding (i.e., by conjunction) that property to Q. In PBT logic, each proof step involves a pattern matching process for finding an inference rule of S that can be applied to a type in S to produce a desired type. This method depends on the use of abstraction, specialization, and the type lattice.

This proof generation process requires time proportional to N×log N (i.e., near linear time) where N is the total number of properties. Each recursive level of the first loop requires proportional to N steps (i.e., the length of S) and has proportional to log N levels (i.e., the height of the lattice) for a total number of steps proportional to N×log N. The second loop is executed at most proportional to 2^{K} (i.e., the number of different contexts with less than K properties)×N (i.e., the worst-case length of T) times. The time for each traditional proof is a function of K and independent of N. Thus, the total time for the second loop is proportional to a constant×N. The total time for a PBT proof is at most proportional to (N×log N)+N, which is proportional to N×log N for large N.

Automated theorem provers using classical logic require proportional to N² or greater time. In practice, N² is sufficiently large that automated theorem provers are impractical for nontrivial applications. With proof times proportional to N×log N, the times for PBT proofs should be dramatically smaller. The difference between N×log N and N² is illustrated in the Table V below.

TABLE V

| N | 10³ | 10⁴ | 10⁵ | 10⁶ | 10⁷ | 10⁸ | 10⁹ | 10¹⁰ | 10¹¹ |
|---|---|---|---|---|---|---|---|---|---|
| N × log N | 3000 | 4 × 10⁴ | 5 × 10⁵ | 6 × 10⁶ | 7 × 10⁷ | 8 × 10⁸ | 9 × 10⁹ | 10¹¹ | 10¹² |
| N² | 10⁶ | 10⁸ | 10¹⁰ | 10¹² | 10¹⁴ | 10¹⁶ | 10¹⁸ | 10²⁰ | 10²² |

Automated Solutions: To automate more of the software development process and to increase user participation in application development are among the primary objectives of PBT systems. Creating practical automated solutions to real problems involves more than generating and executing proofs. The broader process is a human intellectual activity in which only some steps can be automated.

PBT systems can automate more of the software development process because they accept informal characterizations of problems and application domains and do not require data structures, algorithms, programming languages, or computer science methods.

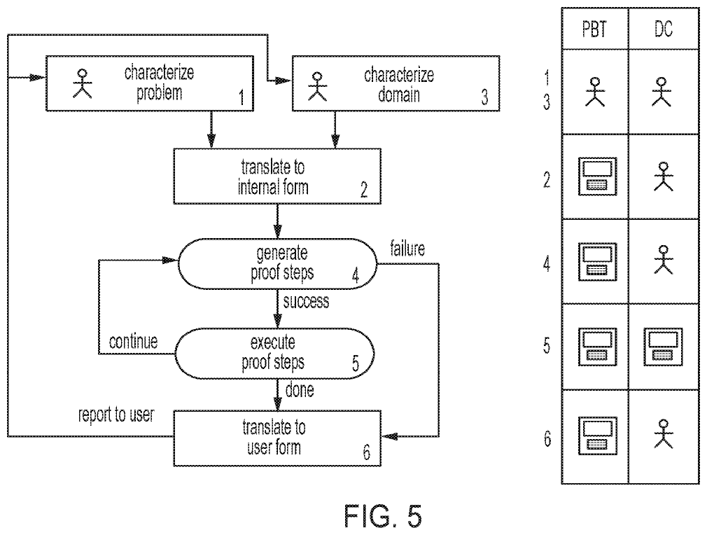

FIG. 5 is a diagram of a software development process according to various embodiments of the present invention. In phase 1, users communicate the problem to be solved to an automated system either directly or through an intermediary (i.e., a programmer). The problem must be communicated in an informal language (e.g., a natural language), preferably using the domain-specific vocabulary of the problem domain. The language must be informal because the information being conveyed is incomplete, vague, and imprecise. The interface between users and the PBT system (or programmer) in phase 1 must be interactive and conversational with the system (or programmer) questioning the user about misunderstandings, inconsistencies, and missing information. Programming languages cannot be used in phase 1 because they demand completeness and are intended for specifying solutions rather than problems.

In phase 2, the problem must be translated to a representational form allowed by the system. In a PBT system, information is represented only by property-based types. Because types are sets of properties and each property corresponds to a declarative sentence in natural languages, the internal representation is one-to-one with users' statements about the problem and the translation can be automated. In a digital computer system, information is represented by data structures and algorithms unique to the problem. The programmer must not only translate the user's requirements to satisfy the needs of a programming language, but must design the data structures and algorithms that will be used. Traditional software development requires specialized knowledge of programming languages and computer science that is seldom available to users.

Solutions also require expert level knowledge of the application domain. In phase 3, domain information is obtained from users and other domain experts using the methods of phase 1. A PBT system asks for needed information when that provided is inadequate to generate a proof. This approach is practical only if domain knowledge is retained in a persistent information repository where it can be used for multiple applications. In a PBT system, all information is translated to the form of property-based types and retained in a persistent knowledge base. In digital computer software development, the programmer must not only obtain and understand the needed application domain expertise, but the programmer's mind also serves as the persistent repository.

In phases 4 and 5, PBT proofs are automatically generated as described earlier. In a PBT system, only a few steps are generated before execution with the advantage that subsequent generation steps can utilize information learned by the execution of earlier steps. In computer systems, the entire program is generated before it is executed with the advantage that programs can be applied to large, regularly structured data without programmers repeatedly generating similar programs. The PBT approach of interleaved generation and execution is most cost effective when the proof generation process is fully automated. The traditional approach of full generation before execution is most cost effective when a programmer must participate in search step the generation process.

In phase 6, the results are translated to a user understandable form as either specified or agree to by the user in phase 1. In a PBT system, phase 6 translates the result to the language of step 1.

The two columns at the right of FIG. 5 indicate which process phases are automated (i.e., indicated by a screen and keyboard) and which are performed manually (i.e., indicated by stick figures) for PBT and digital computer systems, respectively. User participation is crucial and users should be the central participants in application development as shown in phases 1 and 3.

In PBT systems, the remaining phases are automated, significantly increasing the amount of automation in software development.

In digital computer systems, professional programmers are the central participants, only the execution phase is automated, and programmers intervene between the users and the system during the other phases. PBT systems automate certain phases performed by programmers in traditional computer sstems, giving users control over the development process and eliminating the need for developers to have expertise in computer science tools and methods.

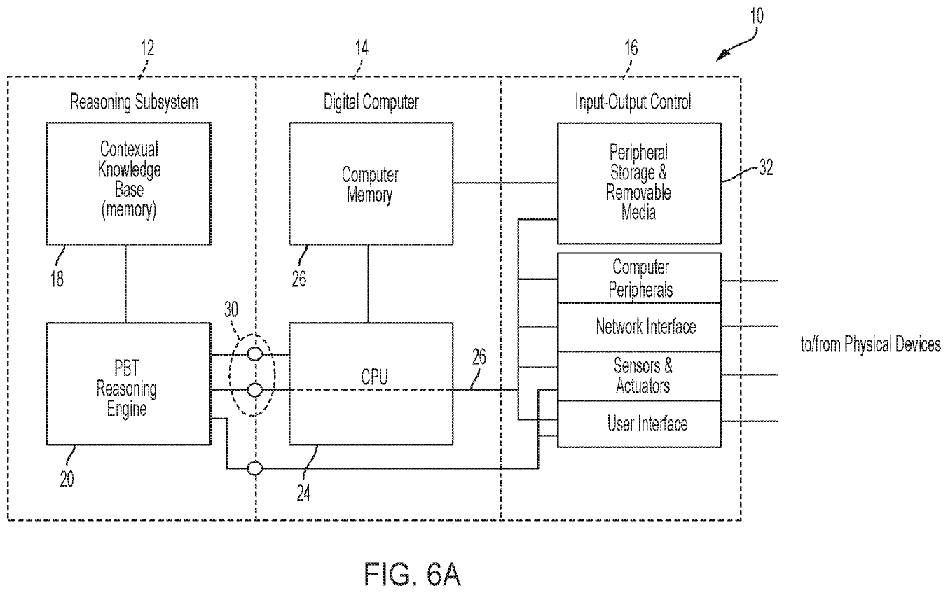

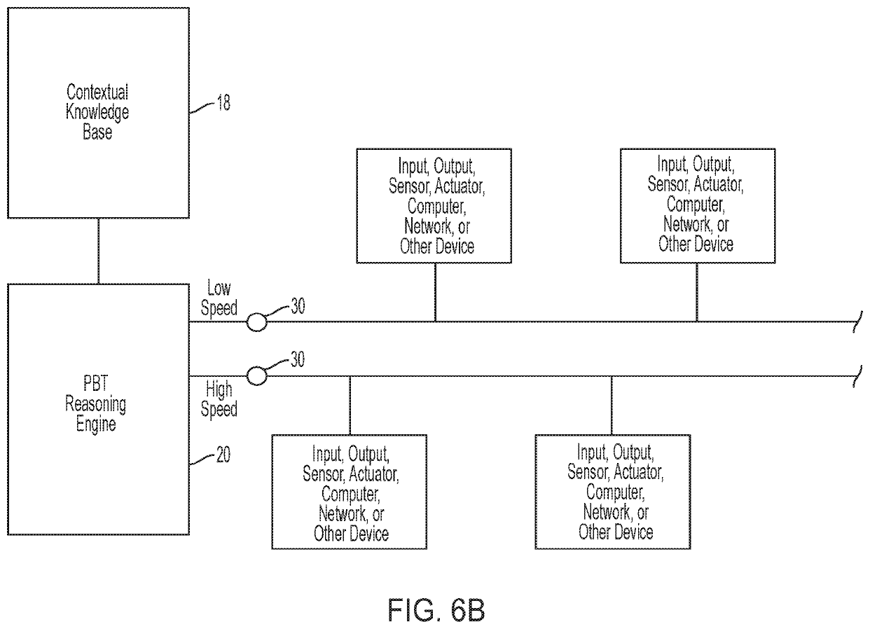

System Architecture: FIGS. 6A and 6B are diagrams of a PBT system architecture 10 according to various embodiments of the present invention. It comprises three subsystems: a reasoning subsystem 12 that provides capabilities unique to PBT logic; a digital computer subsystem 14 that provides functionality that can be implemented more cost-effectively by a digital computer; and an input-output control subsystem 16 that controls devices without detailed management from a computer or reasoning engine.

The reasoning subsystem 12 comprises a contextual knowledge base 18 and a PBT reasoning engine 20. The contextual knowledge base 18 contains persistent knowledge of a PBT system entirely in the form of property-based types, including information about problems, application domains, requirements, constrains, languages, users, system configurations, and any other information useful for development or evolution of an automated application. It is connected only to the PBT reasoning engine 20 because the reasoning engine 20 is the only system component that can understand and process property-based types. The reasoning engine 20 generates proofs using the proof generation process of FIG. 4 and the automated steps of the software development process of FIG. 5. It allocates and disposes memory within the knowledge base 18, manages the overall system, and implements other operating system level functions of a PBT system. At each decision point of its implementation, the reasoning engine maintains the integrity of type incompleteness by avoiding any assumption that types are complete.

Communication among digital devices is restricted to literal values whose interpretations have been established by convention on each connection. Because property-based types are incompatible with the complete logic of digital computers and other digital devices, they cannot be communicated beyond the reasoning subsystem. The small circles on the connections between the reasoning engine 20 and other subsystems shown in FIG. 6A indicate that the reasoning engine 20 must translate information to and from literal values that adhere to those conventions when sending and receiving data. The bottom connection to the reasoning engine 20 allows devices and end users to send interrupt signals directly to the reasoning engine.

The digital computer subsystem 14 may be included for those situations where a computer is more cost-effective than a reasoning engine 20. Although a reasoning engine can perform any task of a digital computer, it is not expected to be as cost-effective for number crunching computations, performing repetitive processes, processing very large data sets, or controlling certain input-output devices. A reasoning engine alone should be most cost-effective for nonmathematical computations, situations where valid results are important, tasks involving infinite data or domains, and applications that are likely to evolve over time.

The computer subsystem 14 comprises a central processing unit (CPU) 24, a main computer memory 26, input-output connections 28, and connections 30 to the PBT reasoning engine 20. The main memory 26 is connected to the CPU 24 and often to peripheral storage 32 and high bandwidth devices through a direct memory access (DMA) interface. There are no specialized requirements for the digital computer except that it have adequate memory capacity, execution performance, and input-output bandwidth to handle its assigned tasks.

The input-output control subsystem 16 includes management and control for devices needed to support the overall system requirements. Devices may include the peripheral storage and removable media 32, user interface devices, access to local and global networks, sensors and actuators, and other peripheral devices.

A PBT system is primarily declarative with users characterizing things using logical, categorical, and designational operations. Users also ask questions and request actions that obtain or alter the state of physical and computational worlds. A few imperative operations, however, are required or no actions would occur. An imperative property is any property with an imperative operation as its primary operation. Imperative properties trigger generation and execution of proofs, communicate with computers and input-output devices, and specify other required actions within the reasoning engine. In that connection, Table VI depicts a set of imperative operations according to various embodiments of the present invention.

TABLE VI
IMPERATIVE OPERATIONS

| | |
|---|---|
| prove [T] | The “prove” operation is used to invoke the PBT proof engine. It applies to |
| | a type T that contains a “what” operation somewhere within its structure. |
| | The intended result of the prove operation is a type S that is equivalent to T, |
| | but with the “what” property replaced by a simpler type. If the proof is |
| | successful, S is returned; otherwise T is returned. |
| communicate [D; V] | The “communicate” operation is a low level input-output operation that can |
| | send and receive information to and from any connected computer or |
| | device. The first argument is a literal that devices interpret as a device |
| | address or unique identity. The second argument is a literal that the device |
| | of the first argument interprets as an instruction with data to be performed |
| | by the device. The result of a communication operation is either a literal |
| | returned by the device, or false indicating a failure in communication with |
| | the device, or true indicating successful communication but no immediate |
| | response from the device. |
| if [C; I; J] | The “if” operation is an imperative conditional operation that executes the |
| | imperative I if and only if type C is consistent and otherwise executes the |
| | imperative J. C may include references to local and global variables of the |
| | reasoning engine, to parameters of a function, to external interrupts, and to |
| | system valuables such as a real time clock. |
| whenever [C; I; J] | Execution of a whenever operation creates a new thread which monitors |
| | condition C for transition from false to true (i.e., for type C to change from |
| | inconsistent to consistent). The imperative type I is then executed. If the |
| | condition has not be satisfied within a fixed time, the imperative type J is |
| | instead executed. Once either I or J is executed, the thread is terminated. |
| retain [T] | The retain operation causes the type T to be persistently retained in the |
| | contextual knowledge base. It differentiates between working types that are |
| | temporarily created and disposed in large numbers in the course of proofs. |
| | Persistent types are retained indefinitely across many different applications |
| | and domains. They logically disappear only through loss of all pointers to |
| | them. |

A prove operation invokes the reasoning engine to answer a specified question. The communicate operation initiates communication to or from a connected input-output device or digital computer. The if operation is a conditional that is used to select among alternative execution paths. The whenever operation is used to create an execution thread and initiate execution on that thread whenever a specified condition transitions from false to true. Retain is used to transfer information to persistent storage.

The proof generation process treats an imperative operation like any other operation. In particular, it does not execute or cause its execution. Imperative operations are executed only as part of the execution of a thread.

At system startup, a single thread is automatically created to execute a boot type that must be imperative. All subsequent execution derives from the boot type or from execution of threads created directly or indirectly by the boot type.

Feasibility of Implementation: When given valid but incomplete information, digital computers, neural nets, artificial intelligence, and statistical methods can answer many questions, but cannot guarantee the validity of their answers. Like classical logic, the logic of digital computers falsely assumes that all domains are complete and thus that all questions have valid answers. Digital computers go further and assume that all relevant information is known.

Because complete information is a limiting case of incomplete information, methods that depend on incompleteness (i.e., incomplete logic) cannot be implemented within a system of complete logic. A complete logic, however, can be implemented within an incomplete logic. Thus, computer programs can be implemented in PBT logic but not vice versa. Assumptions of completeness are built into the design of the machine language instructions of digital computers, but do not exist at the level of the underlying logic of the digital circuit technology from which they are implemented.

The imperative operations, the proof generation process, and the automated portion of the software development process preferably is implemented directly in digital circuit technology to avoid assumptions of completeness that typify computer instruction set architectures and their software. A software implementation is possible but with poorer performance and great risk of unintentionally introducing assumptions of completeness that would undermine the integrity of the implementation.

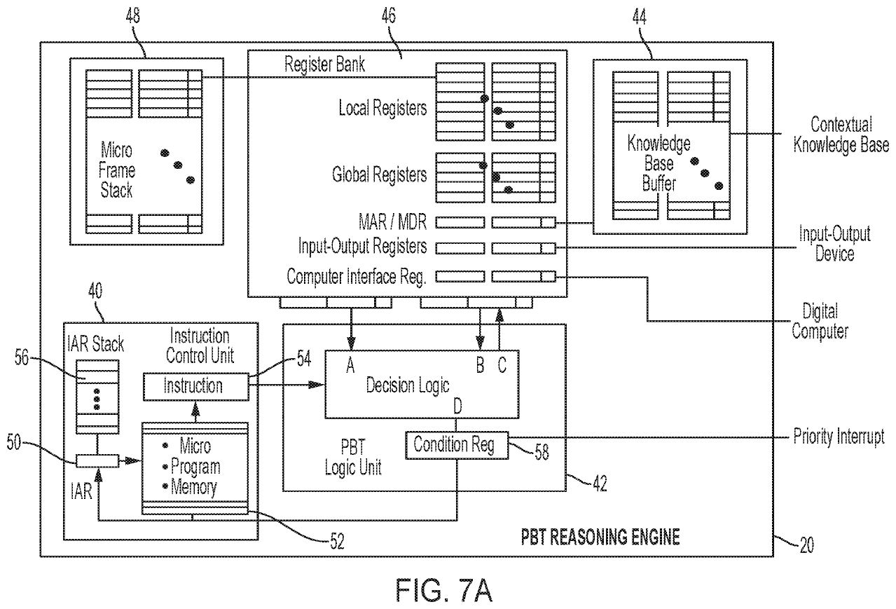

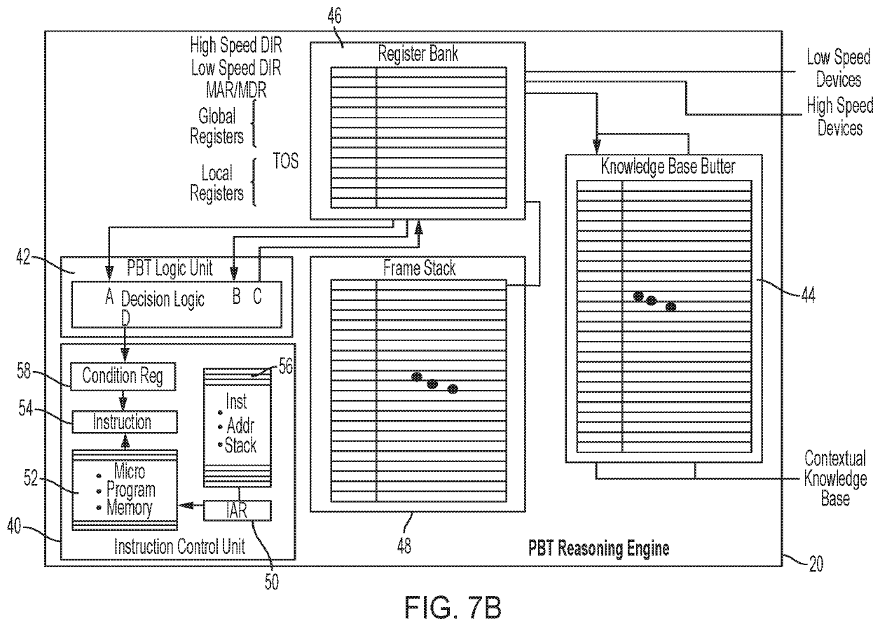

Reasoning Engine: The reasoning engine 20 for the structures and logic of property-based types may implement the proof generation process (as shown in FIG. 4), the automated portion of the software development process (as shown in FIG. 5), and the imperative properties (as shown in Table V). Implementation of a PBT reasoning engine 20 depends on the circuit technology and a variety of system-level tradeoffs. Two depictions of implementations are illustrated in FIGS. 7A and 7B. The implementations of FIGS. 7A and 7B are simpler than most modern CPUs, provide high performance, use employ standard circuit components with minimal special purpose logic.

The PBT reasoning engine as shown in FIGS. 7A-B comprises an instruction control unit 40, a PBT logic unit 42, a knowledge base buffer 44, a bank of general and special purpose registers 46, and a micro frame stack 48.

The content of each register, buffer item, and stack item is a pair consisting of an address within the contextual knowledge base 18 and a copy of the value stored at that address. The address may be to any position within the sequence of elements of a property. Each element value consists of a pointer to a type and a marker indicating whether the element terminates the sequence (as was shown in FIG. 1). Neither the sizes of the units nor the number of registers depicted in FIGS. 7A-B are drawn to scale.

The register bank 46 holds a variety of local and global variables. Local variables are used to implement imperative properties, including the proof generation and software development process. Global variables are used for system management and may contain, for example, the root of all information in the contextual knowledge base, the current domain type, the current problem type, and information needed to process interrupts. Dedicated registers are used to communicate with a computer that may be asked to perform arithmetic and other functions or procedures for which the computer is more cost-effective than the reasoning engine. Other dedicated registers are used to communicate with input-output devices. The memory address (MAR) and memory content (MDR) registers are used to access the knowledge base buffer. When the logic unit changes the content of the MAR, the knowledge base content at that address is then transferred from the knowledge base buffer 44 and the MDR cannot be accessed until the transfer is completed or fails.

The instruction control unit 40 manages the sequencing of instructions. For simplicity and ease of modification, the reasoning engine 20 is horizontally microprogrammable with the combinatorial logic in each of its five units controlled by dedicated bits within each microinstruction. The five units execute in parallel, but are synchronized at the end of each clock interval. The clock interval is chosen to be no less than the maximum gate propagation delay for each unit. More complex asynchronous schemes could be used, but are unlikely to improve overall system performance.

Microinstructions are stored in a microprogram memory that may be read-only. An instruction address register (TAR) 50 holds the address of the next instruction. At the beginning of each clock interval, the current instruction is read from the microprogram memory 52 into the instruction register 54. Because the PBT proof generation process is recursive, an IAR stack 56 (i.e., last-in-first-out memory) is provided to hold the microinstruction addresses for suspended levels of recursion. This scheme provides high performance execution by supporting microprogrammable recursion for functions that would otherwise require microlevel software. The next instruction address may be the next address in sequence, an address specified in the instruction 54, or an address popped from the IAR stack 56. Additionally, setting certain bits in the condition register 58 may trigger an interrupt in which the IAR 50 is pushed to the IAR stack 56 and the IAR 50 is set to the fixed address of the interrupt handler routine.

The PBT logic unit 42 implements the functional decision logic of PBT proofs by comparing properties of known types to patterns defined by the left sides of inference rules. It forms new properties by substituting elements of known properties for corresponding elements of the right side of the matching inference rule. Pattern matching and substitutions of this form are used to implement PBT proofs and automated steps of the software development process. The decision logic typically compares two elements (shown as A and B in the logic unit of FIGS. 7A-B). In simple cases, they need only be identical or have the same constituent elements. In general, type A must be a subtype of B to match and the pattern matching must be applied recursively. Each step of the pattern matching process produces a type and an address where that type should be stored in the knowledge base (both shown as output C from the decision logic). The C output may be written to a designated location(s) in the register bank. The decision logic can also increment and decrement literal values for a variety of purposes including counting the number of types in the sequence of a property. The condition register 58 is a boolean vector of bits that influence the decision logic and can be individually set by the decision logic and, in some cases, by priority interrupts from devices or users. Low priority events are handled through the normal processing of input-output requests.

The knowledge base buffer 44 serves as an intermediary between the reasoning engine 20 and the contextual knowledge base 18 (see FIGS. 6A-6B) to efficiently retrieve information from the contextual knowledge base 18. The buffer 44 contains copies of properties stored in the contextual knowledge base (CKB) 18 together with their CKB address. The knowledge base buffer 44 may comprise a content addressable memory in which the address of each unit of information is stored with the information and does not determine its location within the buffer 44. Whenever the content of the MAR is changed by the logic unit 42, the knowledge base buffer unit 44 finds that address in the pointer column of the buffer 44 and transfers the corresponding content to the MDR register. If the address is not found, the buffer unit 44 reads the content at that address of the contextual knowledge base 18 into the MDR. Whenever the content of the MAR and MDR are simultaneously changed by the logic unit (i.e. in preparation for writing to memory), the content at that MAR pointer position of the buffer is copied from the MDR. If the MAR value is not already in the buffer 44, the MAR and MDR are copied over another element of the buffer 44. Whenever the content of a buffer element is copied from the MDR, the element within the buffer 44 is marked as changed. That element is then copied to the corresponding position of the contextual knowledge base 18 the next time the buffer unit 44 is not busy reading information from the knowledge base 18. Generally, the knowledge base buffer 44 would be implemented with register speed (i.e., single clock) access time while the contextual knowledge base 18 may be much slower. Unlike computers with cached memory and very large pages, the knowledge base buffer efficiently accommodates fine grain data of one of more address lengths.

The micro frame stack unit 48, together with the local registers of the register bank 46, serves as a pushdown stack for local and parameter variables of each recursive level of microprogrammed routines. Before calling a routine, each parameter is pushed into the pushdown stack. That is, each element of the micro frame stack 48 is moved down one position, the top local register is copied to the top element of the micro frame stack 48, the remaining local registers are moved up one position, and the parameter is copied to the bottom local register. Any information overwritten in the bottom element of the micro frame stack is lost. Variables are popped from the frame stack 48 by a reverse process in which local registers are moved down, the top value of the micro frame stack is copied to the top local register, and the elements of the micro frame stack are moved up. Each push or pop operation requires one clock interval for execution independent of the stack size.

In various implementations, the contextual knowledge base 18 can comprise a page-addressable random access memory, with 28 bit addresses and 12 types per page, for example. The memory for the contextual knowledge base may have a speed of 1600 MHz and a capacity ranging from 3 MB to 3 GB, for example. The knowledge base buffer 44 may comprise a page-addressable associative memory, with 28 bit addresses and 12 types per page. The memory for the knowledge base buffer 44, for example, may have a speed of 2 GHz and a capacity of at least 24 KB (i.e., mach faster and smaller than the CKB). The register bank 46 may comprise a duel ported random access memory, 4 to 5 bit addresses, and 124 bits per register. It may comprise 16 or 32 registers, for example, and operate at the clock rate of the reasoning engine. All registers may be addressable as local and global variables. The local registers including the top of stack (TOS) register can be shifted together and serve as an extension to the frame stack. The MAR/MDR registers can be used to control the knowledge base buffer 18. The high-speed and low-speed device interface registers (DIR) are used to control and communicate with connected devices.

The frame stack 48 may comprise a stack of vertical shift registers with external connection only to the top word. It may have an operating speed corresponding to the clock rate for the reasoning engine and a capacity of about 256 words of 124 bits each, for example. The frame stack may server as overflow for stack interpretation of local registers.

The PBT Logic Unit 42 implements the PBT proof generation and automated software development processes described in FIGS. 4 and 5. It may have an operating speed corresponding to the clock rate for the reasoning engine and a capacity of about 160 bits wide with mostly simple comparisons, smaller than the ALU of a CPU.

Micro Program Memory 52 may comprise a random access read only memory (ROM) used to store micro instructions. It may have a speed that is faster than the reasoning engine clock and a capacity of about 500 words of 20 bits each, for example. The IAR Stack 56 may comprise a stack with external connection only to the top word. It may have an operating speed matching the clock rate for the reasoning engine and a capacity of about 64 words of 9 bits each (i.e., allowing up to 512 words or addressable micro prog9am memory), for example.

Informal Languages: The languages of symbolic logic and computer programming are formal to support complete, precise, and unambiguous specifications. Each symbol or word names a constant or variable that represents an operation or another thing, properties are represented by sequences of symbols, and proofs are transformations among strings.

The logic of property-based types is nonsymbolic, does not represent things, and does not use symbols to represent properties or types. Nevertheless, it requires language with vocabulary and grammar for communication with users (see steps 1, 3, and 6 of FIG. 5). The user interface to a PBT system is able to convey information that is incomplete, vague, or imprecise, because it employs an informal language, similar to natural languages, where symbols or words designate incomplete types. With informal language, syntactic ambiguity is often necessary to avoid limiting the expressivity of the language.

In a PBT system, each informal language constitutes a knowledge domain or type that comprises a vocabulary (i.e., naming properties as discussed earlier as shown in Table III), a deep semantic structure, parts of speech, grammatical productions, and grammatical transformations. In a PBT system, the words name types, property-based types constitute the deep semantic structure, parts of speech are linguistic types that categorize words and grammatical productions, and each grammatical production is a property of a part of speech. Grammatical transformations are inference rules derived from the productions. Consequently, analysis and synthesis of informal language is indistinguishable from the standard proof generation process in a PBT system, but requires an adequate vocabulary and grammar. Grammars for informal languages are usually syntactically ambiguous to ensure that the language has the full expressivity of concepts or property-based types. That expressivity often imposes syntactic ambiguities on the language.

When doing linguistic analysis, the proof generation process is able to resolve most syntactically ambiguous sentences (i.e., semantic disambiguation) because unintended parses typically entail inconsistent types. Otherwise, disambiguation must be delayed until additional information is obtained from the vocabulary or other contextual information.

A vocabulary is a set of words that name types in a particular language. The name operation, as shown in Table III, specifies that a word or symbol (i.e., a literal) has a particular part of speech in the designated language. Each use of the name operation is a property of the named type. For example, name[“dog”, noun, English] is a property of type dog. It specifies that the word “dog” can be used as a noun to name dogs in English. Because names are properties, they may be inherited from their supertypes. For example, a dog can also be called a “mammal,” an “animal,” or a “thing.” Although the number of useful types is arbitrarily large, the number of short words is small. The number of words needed can be kept small by naming only a few important types (i.e., nouns and verbs) and a few modifier types (i.e., adjectives, adverbs, and propositions). An unnamed type can be designated by a combination of its supertype and modifiers that restricts the supertype to the intended type. For example, the modifiers “big” and “green” can be combined with the noun “bird” to designate a big green bird without defining a separate word for the big green bird type. Some language researchers believe that Neanderthals had larger brains but more limited reasoning abilities than humans because their language did not use modifiers and thus required large capacity to hold enormous numbers of named noun and verb types. Modifiers create demand for reasoning ability to process complex grammars.

A grammar is a type that characterizes the sentences of a language and specifies their corresponding deep structures. A grammar is a union of the language's parts of speech where each part of speech (i.e., a type) is a disjunction of alternative productions. Each production (i.e., a property) is an implication where one side defines an allowed sequence of parts of speech and the other side specifies the corresponding deep structure. For linguistic analysis, the PBT proof generation process interprets a production as an inference rule from the linguistic form to the corresponding property-based type and vice versa for linguistic synthesis.

Although each sentence expresses a property of its subject, its meaning is neither directly nor completely determinable from the types named by its words. The meaning extends beyond a relationship among the parameter's types to include properties of those types and other types appearing within the properties of those types to any number of levels. Informal languages differ from one another, not only in their grammar and choice of words, but also in which types are named. A language can express a property only in terms of types that have names in that language. Thus, types that may be expressed by a single word in one language may require a phrase in another language.

Given a vocabulary, a grammar, and a deep semantic structure as characterized by property-based types, the software development process as implemented by the reasoning engine constitutes a new method for analysis and synthesis of informal languages. In particular, language synthesis is the process of answering (i.e. a PBT proof) what sequence of words in the target language is entailed by the grammar and vocabulary of the language and the PBT type of the deep structure of the sentence to be expressed. Conversely, language analysis is the process of answering what deep structure types is entailed by the source language and vocabulary and the sequence of words in the sentence. Thus, the PBT software development process constitutes a new method for linguistic analysis and synthesis of informal languages and for natural language processing (NPL) in particular.

Illustrative Grammar: In a PBT system, any desired language may be used in the user interface as long as it has an adequate grammar and vocabulary. Similarly, simultaneous use of multiple languages is allowed and may share certain vocabulary.

A natural language is an obvious choice because it is demonstratively adequate and may already be known to users, but its grammar may be sufficiently large, ambiguous, and difficult to easily characterize as a PBT type. A better choice may be an auxiliary language that is similar to a natural language but has a simplified grammar and, at least initially, a more limited vocabulary.

Table VII depicts an illustrative grammar for a PBT system, in particular a few productions from an English-like informal language. For ease of understanding, Table VII uses a regular expression notation to specify the grammar. In general, however, a regular expression notation is inadequate because it does not accommodate context dependencies. In this illustration, identifiers name parts of speech, “::=” separates and names parts of speech, “|” separates alternatives within a part of speech; quoted words and symbols indicate terminals of the grammar, “[” and “]” enclose optional sequences, and “{” and “}” enclose sequences that may be repeated one or more times. Table VII shows the source language forms but not the corresponding type structure.

TABLE VII
ILLUSTRATIVE GRAMMAR

| Grammar Spec | Use | Example |
|---|---|---|
| declarative ::= subject is | subtype specification | dogs are animals |
| subject | | |
| \| subject is adjective | attribute specification | the dog is brown |
| \| subject is prepN | prepositional specification | the box is on the table |
| \| subject is possessive | possessive specification | the book is John's |
| \|s ubject does [{adverb}] | action with infinitive | Fido does chase cars |
| actionW [object] [{propV}] | | |
| \|subject actionC [object] | action with verb conjugation | Fido chases cars |
| \| “there” is subject | existence specification | there are many good ideas |
| subject ::= designation | | the five green apples on the |
| [{adjective}] typeW [prepN] | | table |
| adjective ::= [{adverb}] | | light green colored |
| adjectiveW [dimensionW] | | |
| adverb ::= adverbW \| | | very quickly |
| adverbW [adverb] | | |
| prepN ::= nounPrepW object | | on the table |
| prepV ::=verbPrepW object | | into the garage |
| designation ::= [article] | | the five |
| [quantity] | | |
| \| [article] possessive [quantity] | | a dog's five |
| \| article ordinal | | the fifth |

The grammar shows a portion of the language. The parts of speech that are shown include: declarative, subject, object, is, does, actionW, actionC, adjective, adverb, prepN, prepV, possessive, designation, article, quantity, and ordinal. The first seven lines show the seven forms of declarative sentences in English. The first alternative of the declarative part of speech is a sequence consisting of a subject, an is, and an adjective where subject, is and adjective are each parts of speech. Is, does, and actionC categorize any phrase in the congregation of the verbs to be, to do, and an action verb, respectively. Names ending in W indicate that the form is limited to a single word and, in the case of actionW, to the infinitive form of an action verb.

User Perspective: The purpose of this invention, in various aspects, is to create a new class of automated systems that does not suffer the limitations of digital computers. More broadly, it is intended to fulfill the longstanding vision of automated systems as enablers of an intellectual revolution by multiplying human reasoning abilities.

An automated system of property-based types is characteristically different from traditional digital computers. From a user perspective, a PBT system has several distinguishing features:
It can validly characterize whatever is known without requiring unknown information.
It can reason about things using an incomplete higher-order intensional logic that guarantees valid results, but cannot answer certain questions without additional information.
Its logic can exploit abstraction, generalization, analogy, and other inference rules not previously available in automated systems.
It can dialog with users in informal language, including asking and answering questions and conversing in declarative sentences about any subject.
It can learn rapidly, ask questions for clarification, and point out inconsistencies, but requires a critical mass of information about each domain before it can effectively reason, answer questions, or develop applications for that domain.
It can persistently retain information in a form that is domain and language independent. Together with intensional interpretations and intrinsic meaning, the persistent knowledge may enable automated imagination and creativity.
It can communicate with and control digital computers to obtain services for which a computer is more cost-effective than a PBT reasoning engine, including certain mathematical computations, real-time control of devices, and repetitive processing of large data sets.
It can cost-effectively communicate with, control, and manage input-output devices when that management is either trivial or too complex to be within the capabilities of digital computers.
It does not require use of data structures, algorithms, programming languages, or computer science techniques by the developers, users, or maintainers of applications. It does not impose programmers between end users and their applications, but often requires extensive knowledge of the application domain and problems to be solved.

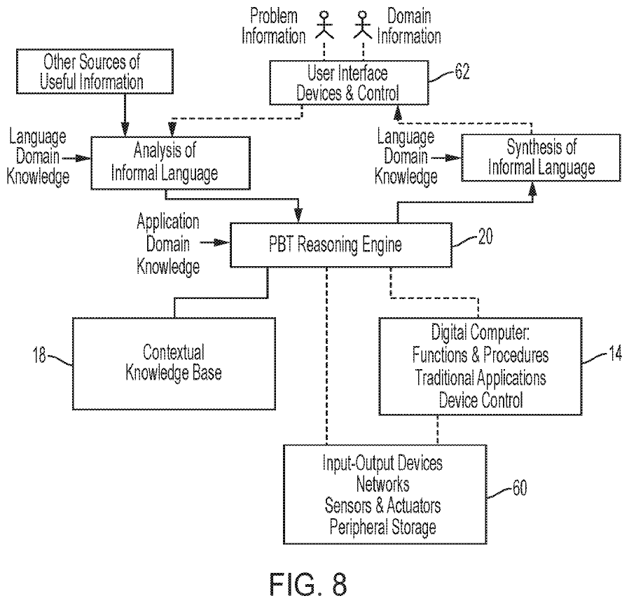

A PBT system generally requires, in various embodiments, an informal linguistic interface, the PBT reasoning engine 20, the contextual knowledge base 18, and appropriate input-output devices 60, as shown in the example user perspective architecture shown in FIG. 8. Each rectangle represents a function or process of the system. Connecting lines show information or data flow with solid lines indicating information represented as property-based types that can be directly understood by the reasoning engine and with dotted lines indicating data in the form of bit patterns conforming to established conventions.

At the top of FIG. 8, development and use of an application requires extensive knowledge of the problem and its application domain. Such information typically comes from end users and other domain practitioners and enters the system in an informal linguistic form through an input device 62 such as a keyboard or microphone. Information can also be obtained indirectly from sources such as documents.

Any language known to the system may be used as the user interface language, but the initially provided language is an auxiliary language similar to English. To analyze and translate input from a particular language, the PBT system must know the grammar and certain vocabulary of the language.

The vocabulary can be extended within a language either by explicit definition or by incidental use from which an incomplete characterization can be inferred. The linguistic input is translated into property-based types that constitute a language-independent incomplete characterization of the things designated by the input. The resulting translation can be semantically ambiguous and sometimes syntactically ambiguous.

The PBT reasoning engine 20, as shown in FIG. 8, processes the translated types to eliminate ambiguities, answer questions, respond to imperatives, ask questions, and solve whatever problems may arise. Information in the contextual knowledge base is available to solve problems either directly, by deductive inference, or by analogy. When the available information is inadequate, the system may ask the user for clarification or additional information.

A PBT system may call on a digital computer 14 for services such as evaluating functions, executing procedures, or controlling input-output devices, where the computer is more cost-effective than the reasoning engine. A PBT system could generate a digital computer application automatically, but first would have to be given knowledge of data structures, algorithms, the target computer, and computer science methods.

Questions, answers, and other forms of results from the system are normally in the form of property-based types that must be translated into informal language before presentation to the user. Linguistic synthesis uses the same vocabulary as linguistic analysis, but typically a less permissive grammar because synthesis, unlike analysis, need not correct a variety of user-generated grammatical errors. Some results require control and use of sensors, actuators, networks, peripheral storage, or conventional input-output devices with or without a digital computer as an intermediary.

Actual applications might include a personal reasoning assistant that learns from the user, assists the user in reasoning more rapidly and reliably, explains problems and solutions, and helps solve problems that are too complex or too error prone for the user to solve alone. Other applications might include solving complex multi-domain problems with input from experts in different domains each using the specialized vocabulary of their own domain, but integrated into a consistent whole of property-based types. They might include linguistic analysis with input from one language being translated into property-based types as a deep semantic structure and then synthesized into another language. They might include traditional digital computer applications but with a PBT reasoning engine to provide more intelligent responses to unanticipated situations. They might replace semiautonomous applications where it is desirable to know and inform users when a valid or correct answer is impossible or otherwise cannot be guaranteed.

In one general aspect, therefore, the present invention is directed to an automated system that uses a recursive information structure for validly, but incompletely characterizing anything imaginable; for representing declarative, interrogative, and imperative properties; for calculating with infinite domains; and for enabling intrinsic meaning. The automated system further uses a logic that is incomplete to support application domains where complete knowledge is impossible or unavailable and to guarantee valid results in the absence of complete information; higher-order to ensure valid proofs without introducing paradoxes or nonmonotonicity; and intensional to characterize meaning rather than modeling or representing things.

The automated system further comprises a knowledge base for storing contextual and other information in the form of the recursive information structure and for representing information about problems, application domains, requirements, constrains, languages, users, system configurations, that are relevant to an automated application. The automated system further uses imperative properties to trigger generation and execution of proofs; communicate with computers and input-output devices; and specify other required actions. In addition, the automated system executes a software development process involving declarative specifications of applications using informal language; increasing user participation in application development; and eliminating the need for developers to understand data structures, algorithms, programming languages, or computer science methods.

In various implementations, the automated system comprises a reasoning engine as described herein; a digital computer for computing functions, performing procedures, managing input/output devices, and executing traditional computer applications in situations where a computer is more cost-effective than the reasoning engine; input/output control devices for efficient control and management of user interface devices, sensory feedback and actuator control devices, network interfaces, peripheral storage, and other input-output devices where a dedicated controller is more cost-effective than the reasoning engine; an interface for communication among the reasoning engine, the digital computer(s), and the input-output controls; and an informal linguistic interface for translating from a human understandable form to the information structure form and vice versa to ensure that any known property can be expressed without specifying unknown properties, comprising analysis and synthesis processes for an informal or auxiliary language.

In various implementations, the recursive information structure of the automated system comprises a pointer to a sequence of the information structures, where one element of the sequence characterizes an operation and the remaining elements characterize arguments to that operation. In addition, the logic described above may comprise: (a) a set of inference rules including abstraction, generalization, and analogy; and (b) a proof generation process that uses the inference rules described above, standard proof methods, and a specialized search process to perform proofs in near linear time.

The reasoning engine described above implements the proof generation process using information in the knowledge base, executes the imperative properties, and performs the automated portion of the software development process. To that end, the reasoning engine may comprise (a) an instruction control unit for controlling the execution order of imperative properties; (b) a logic unit for implementing the functional decision logic of the imperative properties; (c) a knowledge base buffer to retrieve information from the knowledge base efficiently; (d) a register bank for holding local and global variables used by the logic unit for interfacing with the knowledge base buffer, the computer, and the input-output devices; and (e) a micro frame stack or other mechanism for holding local variables of temporarily suspended routines, including for the recursive proof generation process.

In another general aspect, the present invention is directed to a logic system that comprises an electronic memory-based contextual knowledge base that stores knowledge represented by property-based types (PBTs). In this context, a PBT validly characterizes a category of things and is represented by a recursive structure consisting of a pointer to a sequence of PBT types and interpreted as a logical composition of properties. The logic system further comprises a reasoning engine in communication with the contextual knowledge base. The reasoning engine comprises electronic circuitry and includes microprogrammed functions. The reasoning engine implements and executes a PBT decision logic as required by a PBT proof generation process or an automated software development process by applying inference rules as specified by a type lattice of known PBTs. In various implementations, the result of the application of the inference rules is a new, valid PBT, such that valid results are a consequence of the use of the PBTs, the interference rules, and the PBT decision logic. The type lattice is a lattice rather than a cyclic list structure. It is a substructure of the knowledge base that retains only properties whose operation form a logical composition (e.g., conjunction, disjunction, and negation). As such, the lattice shows the subtype relationships among PBTs and is used to determine allowed inferences during the proof generation and execution processes.

In another general aspect, the present invention is directed to a method of performing logic proofs. The method comprises the step of storing, in an electronic memory-based contextual knowledge base, knowledge represented by property-based types (PBTs), wherein a PBT validly characterizes a category of things and is represented by a recursive structure consisting of a pointer to a sequence of types and interpreted as a logical composition of properties. The method further comprises the step of generating a PBT proof, by using a reasoning engine that is in communication with the contextual knowledge base and applying inference rules as specified in a type lattice to known PBTs, with the result of the application of the inference rules being a new, valid PBT.

In various implementations of the above-described logic system and method, the PBT decision logic is a calculus of PBTs that proves the consistency of PBTs rather than entailment of properties. Further, the reasoning engine may operate only on PBTs. Still further, the number of execution steps by the reasoning engine in generating a PBT proof is near-linear relative to the number of properties and independent of the number of things characterized by those properties.

In various implementations, the reasoning engine further comprises a register bank, a content addressable knowledge base buffer, and a PBT logic unit. The knowledge base buffer is in communication with the contextual knowledge base and the register bank. The knowledge base buffer serves as an intermediary between the contextual knowledge base and the register bank. Further, the register bank may comprise memory address registers and memory content registers for accessing data stored in the knowledge base buffer. Also, the register bank may further comprise a first set of registers for storing PBTs created or used by the PBT decision logic. In addition, the reasoning engine may further comprise an instruction control unit that is in communication with the PBT logic unit. The instruction control unit may comprise: (i) a read-only microprogram memory that stores microinstructions that control the operation of the reasoning engine; (ii) an instruction register that stores a next microinstruction to be executed by the reasoning engine, which is read from the microprogram memory into the instruction register; and (iii) a last-in-first-out instruction register stack that stores microprogram addresses to be used upon return from recursive microprogram routines. Also, the register bank may comprise device interface registers for connection to and control of any number of devices separate from the reasoning engine and conceptual knowledge base. Such separate devices may include, but are not limited to, a sensor, an actuator, a digital computer, a user interface device, a real-time clock, a computer peripheral, a network interface, a storage device, an AI or neural net device, and/or removable media.

In various implementations, by validly, but incompletely, characterizing a category of things, a PBT characterizes each thing in the category and the reasoning engine guarantees valid results because it soundly uses the incomplete characterizations that are composed only from properties that are known to be valid.

Although various embodiments have been described herein, many modifications, variations, substitutions, changes, and equivalents to those embodiments may be implemented and will occur to those skilled in the art. It is therefore to be understood that the foregoing description and the appended claims are intended to cover all such modifications and variations as falling within the scope of the disclosed embodiments. The following claims are intended to cover all such modifications and variations.

In summary, numerous benefits have been described that result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as suited to the particular use contemplated.

1. An automated logic system comprising:
an electronic memory-based contextual knowledge base that stores knowledge represented by property based types (PBTs), wherein a PBT validly characterizes a category of things and is represented by a recursive structure consisting of a pointer to a sequence of types and interpreted as a logical composition of properties; and
a reasoning engine in communication with the contextual knowledge base, wherein the reasoning engine comprises electronic circuitry, including microprogrammed functions, that implements PBT decision logic as required by a PBT proof generation and execution process by applying inference rules as specified in a type lattice to known PBTs, with the result of the application of the inference rules, the PBTs and the PBT decision logic being a new valid PBT, wherein the PBT decision logic comprises an incomplete, higher-order logic.

2. The automated logic system of claim 1, wherein the PBT decision logic is a calculus of PBTs that directly prove consistency of PBTs rather than entailment of properties.

3. The automated logic system of claim 2, wherein the reasoning engine operates only on PBTs.

4. The automated logic system of claim 1, wherein the number of execution steps by the reasoning engine in generating a PBT proof is near-linear relative to the number of properties.

5. The automated logic system of claim 1, wherein the type lattice comprises a parent type and a plurality of subtypes, and wherein properties of each of the subtypes are a superset of properties of the parent type and every subtype of the plurality of subtype characterizes a subset of examples of the parent type.

6. The automated logic system of claim 1, wherein the PBT decision logic allows the law of the excluded middle with respect to consistency of types.

7. The automated logic system of claim 1, wherein the PBT proof generation and execution process is monotonic, such that the PBT proof generation and execution avoids invalidation of proofs when additional information is provided, by proving consistency of types.

8. The automated logic system of claim 1, wherein a property is a relationship comprising constituent types, wherein the constituent types comprise a subject, an operation, and zero or more additional arguments, wherein the subject, operation, and zero or more additional arguments are types.

9. The automated logic system of claim 8, wherein an operation of a property comprises an operation selected from the group consisting of a logical operation, a categorical operation, a designational operation, and an imperative operation.

10. The automated logic system of claim 8, wherein an intensional interpretation of a type recursively includes the interpretations of its constituent types.

11. The automated logic system of claim 1, wherein:
the reasoning engine further comprises:
a register bank; and
a content addressable knowledge base buffer that is in communication with the contextual knowledge base and the register bank, wherein the knowledge base buffer is for serving as a buffer between the contextual knowledge base and the register bank; and
the register bank comprises memory address registers and memory content registers for accessing data stored in the knowledge base buffer.

12. The automated logic system of claim 11, wherein the register bank further comprises a first set of registers for storing PBTs created or used by the PBT decision logic.

13. The automated logic system of claim 12, wherein the reasoning engine comprises a PBT logic unit that implements PBT decision logic, wherein the PBT logic unit is in communication with the register bank.

14. The automated logic system of claim 13, wherein the reasoning engine further comprises an instruction control unit in communication with the PBT decision logic.

15. The automated logic system of claim 14, wherein the instruction control unit comprises:
a read-only microprogram memory that stores microinstructions that control the operation of the PBT logic unit;
an instruction register that stores a next microinstruction to be executed by the PBT logic unit, that is read from the microprogram memory into the instruction register; and
a last-in-first-out instruction register stack that stores microprogram addresses to be used upon return from recursive microprogram routines.

16. The automated logic system of claim 11, wherein the register bank comprises device interface registers for connection to and control of a device separate from the reasoning engine and conceptual knowledge base.

17. The automated logic system of claim 16, wherein the device separate from the reasoning engine and conceptual knowledge base comprises a device selected from the group consisting of a sensor, an actuator, a digital computer, a user interface device, a real-time clock, a computer peripheral, a network interface, a storage device, and removable media.

18. The automated logic system of claim 1, wherein:
by validly characterizing a category of things, a PBT incompletely characterizes each thing in the category; and
the reasoning engine uses the incompleteness of PBTs and the PBT decision logic to guarantee that the new PBT is valid.

19. The automated logic system of claim 1, wherein the reasoning engine is further configured to implement the PBT decision logic as required by a software development process.

20. The automated logic system of claim 19, wherein the software development process comprises a new method for linguistic analysis and synthesis of informal languages.

21. A method of performing logic proofs comprising:
storing, in an electronic memory-based contextual knowledge base, knowledge represented by property based types (PBTs), wherein a PBT validly characterizes a category of things and is represented by a recursive structure consisting of a pointer to a sequence of types and interpreted as a logical composition of properties; and
generating a PBT proof, by a reasoning engine that is in communication with the contextual knowledge base and that implements a PBT decision logic as required by a PBT proof generation and execution process, by applying inference rules as specified in a type lattice to known PBTs, with the result of the application of the inference rules being a new PBT, wherein the PBT decision logic comprises an incomplete, higher-order logic.

22. The method of claim 21, wherein the PBT decision logic is a calculus of PBTs that directly prove consistency of PBTs rather than entailment of properties.

23. The method of claim 22, wherein the reasoning engine operates only on PBTs.

24. The method of claim 21, wherein the number of execution steps by the reasoning engine in generating a PBT proof is near-linear relative to the number of properties.

25. The method of claim 21, wherein the type lattice comprises a parent type and a plurality of subtypes, and wherein properties of each of the subtypes are a superset of properties of the parent type and every subtype of the plurality of subtype characterizes a subset of examples of the parent type.

26. The method of claim 21, wherein the PBT decision logic allows the law of the excluded middle with respect to consistency of types.

27. The method of claim 21, wherein the PBT proof generation and execution process is monotonic, such that the PBT proof generation and execution avoids invalidation of proofs when additional information is provided, by proving consistency of types.

28. The method of claim 21, wherein a property is a relationship comprising constituent types, wherein the constituent types comprise a subject, an operation, and zero or more additional arguments, wherein the subject, operation, and zero or more additional arguments are types.

29. The method of claim 28, wherein an operation of a property comprises an operation selected from the group consisting of a logical operation, a categorical operation, a designational operation, and an imperative operation.

30. The method of claim 28, wherein an intensional interpretation of a type recursively includes the interpretations of the constituent types of the type.

31. The method of claim 21, wherein:
the reasoning engine comprises:
a register bank; and
a content addressable knowledge base buffer that is in communication with the contextual knowledge base and the register bank, wherein the knowledge base buffer is for serving as a buffer between the contextual knowledge base and the register bank; and
the register bank comprises memory address registers and memory content registers for accessing data stored in the knowledge base buffer.

32. The method of claim 31, further comprising storing, in a first set of registers of the register bank, PBTs created or used by the PBT decision logic.

33. The method of claim 32, wherein the reasoning engine comprises a PBT logic unit that implements PBT decision logic, wherein the PBT logic unit is in communication with the register bank.

34. The method of claim 33, wherein the reasoning engine further comprises an instruction control unit in communication with the PBT decision logic.

35. The method of claim 34, wherein the instruction control unit comprises:
a read-only microprogram memory that stores microinstructions that control the operation of the PBT logic unit;
an instruction register that stores a next microinstruction to be executed by the PBT logic unit, that is read from the microprogram memory into the instruction register; and
a last-in-first-out instruction register stack that stores microprogram addresses to be used upon return from recursive microprogram routines.

36. The method of claim 21, wherein:
by validly characterizing a category of things, a PBT incompletely characterizes each thing in the category; and
the reasoning engine uses the incompleteness of PBTs and the PBT decision logic to guarantee that the new PBT is valid.
